(19) United States
(12) Patent Application Publication
(10) Pub. No.: US 2012/0264879 A1
(43) Pub. Date: Oct. 18, 2012

(54) PRODUCING COATINGS BASED ON LCST POLYMERS

(75) Inventors: Thomas WEISS, Ilvesheim (DE); Hans-Peter Seelmann-Eggebert, Limburgerhof (DE); Christian Hubert Weidl, Speyer (DE); Roman Benedikt Raether, Speyer (DE)

(73) Assignee: Basf Se, Ludwigshanfen (DE)

(21) Appl. No.: 13/438,122

(22) Filed: Apr. 3, 2012

Related U.S. Application Data
(60) Provisional application No. 61/474,318, filed on Apr. 12, 2011.

(51) Int. Cl. C09D 133/08; B05D 3/00

(52) U.S. Cl. 524/854; 427/314

(57) ABSTRACT

This invention relates to a process for producing coatings based on an LCST polymer and to formed articles obtainable by the process.

This invention relates to a process for producing coatings based on an LOST polymer and to formed articles obtainable by the process.

LCST polymers based on polyalkylene oxides are known. LCST is short for lower critical solution temperature, and an LOST polymer is a polymer which is soluble in a liquid medium at a lower temperature but precipitates from the liquid medium above a certain temperature, the LCST temperature. This process is reversible, so the system becomes homogeneous again on cooling down. The temperature at which the solution clarifies on cooling down is known as the cloud point (see German standard specification DIN EN 1890 of September 2006). This temperature is characteristic for a particular substance.

WO 01/60926 A1 discloses a process for coating particles with LOST polymers wherein the LOST polymer is dissolved in a solvent at below the LOST, the solution obtained is mixed with the particles to be coated, and then the temperature of the mixture obtained is raised to a temperature above the LOST to precipitate the LOST polymers on the particle surfaces.

WO 2004/046258 A2 discloses LOST polymers based on polyalkylene oxides terminally substituted with an optionally substituted acrylate. WO 2004/046258 A2 further discloses using these LOST polymers for coating particles and non-particulate substrate surfaces by contacting the polymers in a liquid medium with the particles and surfaces, respectively, at below the LOST temperature, raising the temperature to above the LOST temperature and polymerizing the polymers on the surface of the particles, and on the surfaces, respectively, via the double bonds at this or a higher temperature.

The known LOST polymers and the known processes for coating with these polymers do not meet increased expectations.

The problem addressed by this invention was therefore that of providing an improved coating process.

The invention provides a process for producing coatings based on an LOST polymer P on the surface of a formed article from a meltable substrate S, more particularly on fibers in a melt-spinning process or self-supporting films after extrusion, which process comprises
a) providing the substrate in molten form,
b) forming the molten substrate via a suitable device V, preferably a die or slot, into a formed article, more particularly into a fiber or a self-supporting film, wherein
c) the formed article has a temperature above the cloud point of said polymer on exit from said device V, and
d) contacting the surface of the formed article with said polymer P above said cloud point to deposit the polymer,
wherein said polymer P comprises polymerizable double bonds and the polymerization of the double bonds is initiated after deposition of the polymer on the surface to form a preferably crosslinked coating on the surface.
The cloud point is determined in accordance with German standard specification DIN EN 1890 of September 2006, procedure as per method E. The cloud point is preferably in the range from 40 to 80° C. and more particularly in the range from 60 to 80° C.

According to this procedure as per method E, 5 g of sample were introduced into an Erlenmeyer flask and admixed with 25 g of the aqueous solution of diethylene glycol mono-n-butyl ether (BDG) having a mass fraction of 25%. The mixture is stirred until the sample has formed a clear solution. A heating device is then used to heat the liquid under slow agitation until it is completely cloudy. This is followed by gradual cooling under agitation. The temperature at which the cloudiness disappears, i.e., the solution clarifies, is the cloud point.

In a preferred embodiment,
the formed article after emergence from said device V is led into a preferably aqueous bath B comprising said polymer P and optionally a polymerization initiator, wherein the temperature is chosen such that as it enters the bath the formed article has a temperature above the cloud point,
said polymer P deposits on the formed article, and
the bath has a temperature below the cloud point and
the polymerization is performed at a temperature below the cloud point.

In a further preferred embodiment, the formed article emerging from said device V is immediately thereafter led at a temperature above the cloud point into a spraying device and is sprayed therein with said polymer P, preferably in the form of an aqueous solution, wherein the temperature of the spray-dispensed polymer P is below the cloud point, to deposit the polymer on the surface of the substrate.

In a preferred embodiment, said polymer P is a polyalkylene oxide having at least two terminal optionally substituted acrylic acid radicals, wherein the optionally substituted acrylic acid radical is an acrylic or methacrylic acid radical.

In a particularly preferred embodiment, said polymer P is a polyalkylene oxide of the following general formula I:

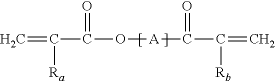

where
Rₐ and R_{b} are each independently hydrogen or an alkyl radical, more particularly of 1-4 carbon atoms, more particularly methyl,
A is at least one radical of the formula

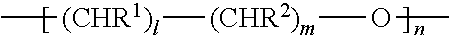

where two or more radicals A may be the same or different and where
R¹ to R² are the same or different and are each H, C1- to C5-alkyl, more particularly methyl, ethyl, propyl or aryl, more particularly phenyl,
l is 1 or 0
m is 1 or 0 provided l+m is at least 1,
n is from 1 to 100.
Particularly preferred radicals A are

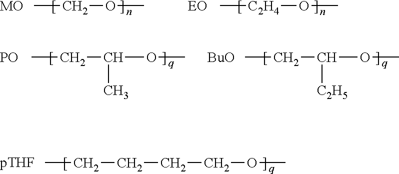

where n and q are the same or different and are each a number from 1 to 100.

In a very particularly preferred embodiment, A is a radical comprising at least one of the following radicals A1 and A2:

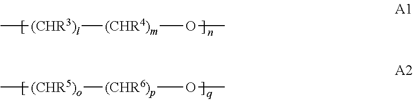

where
R³ to R⁶ are the same or different and are each H, C1- to C5-alkyl, more particularly methyl, ethyl, propyl or aryl, more particularly phenyl,
l is 1 or 0
m is 1 or 0 provided I+m is at least 1,
n is from 1 to 100,
o is from 0 to 5,
p is from 0 to 5 provided o+p is from 3 to 5,
q is from 1 to 100.

A preferably consists of the radicals A1 and A2 and more particularly is the group -A2-A1-A2- or -A1-A2-A1-.

The recurring units in the radicals A1 and A2 may form a random distribution or a blockwise arrangement.

When the radical A2 includes not only propylene glycol radicals but also polytetrahydrofuran units, it is a preferred embodiment for the polytetrahydrofuran units to be terminally disposed.

The radicals A1 and A2 may be substituted, more particularly with an alkyl radical of 1-4 carbon atoms or an aryl radical, more particularly phenyl. An example of a substituted recurring radical is the phenyl-substituted ethylene glycol radical (styrene oxide).

Very particularly preferred polymers P conform to the following formula:

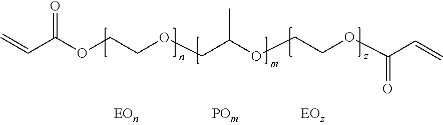

where
n and z are the same or different and are each from 5 to 100 and more particularly from 20 to 40,
m is from 5 to 100 and more particularly from 15 to 30.

Particularly preferred substrates are polyamides, polyester, polypropylene or polyurethanes. In a further preferred embodiment, the substrate is a glass, steel or wood.

The polymerization of the double bonds can be performed in bath B or subsequently to the treatment in bath B. To initiate the polymerization, it is preferable to add a polymerization initiator.

Polymers P to be used according to the present invention are preferably polymerized free-radically, more particularly from an aqueous or alcoholic solution. The polymerization is preferably carried out in the presence of free-radical formers, more particularly organic or inorganic peroxides, azo compounds or metals/organometallic compounds. The molar mass of the polymers obtained may be controlled by adding suitable chain transfer agents, more particularly mercaptans, organic halogen compounds, xanthates or nitroxyl free radical formers. The polymerization temperature is preferably in the range from 50 to 100° C. and more particularly in the range from 60 to 80° C.

The polymerization of the acrylate groups of the compounds of formula I according to the present invention can also be initiated using a photoinitiator. Photoinitiator quantities used are generally in the range from 0.01% to 10% by weight and more particularly from 0.01% to 3% by weight, all based on the compound of formula I. The compounds useful as photoinitiators are capable on exposure to actinic light of forming free radicals and of inducing a rapid photopolymerization of the compound of formula I. Possible photoinitiators include, for example, acyloins and acyloin ethers, aromatic diketones and their derivatives and polynuclear quinones.

Of particular suitability are benzoin and alpha-hydroxymethylbenzoin methyl ether or benzoin methyl ether, benzoin isopropyl ether, benzil monoketals such as benzil dimethyl ketal, benzil methyl ethyl ketal, benzil methyl benzyl ketal, benzil neopentyl ketal or diarylphosphine oxides as described in German Laid-Open Specification DOS 29 09 992, preferably 2,6-dimethoxybenzoyldiphenylphosphine oxide and more particularly 2,4,6-trimethylbenzoyldiphenylphosphine oxide. Preference is given to photoinitiators in terms of type and amount such that they need only short minimum exposure times, preferably not more than a few minutes, to initiate the photopolymerization on imagewise exposure to actinic light, more particularly UV light.

When photoinitiators are used, there may in addition also be used inhibitors of thermal polymerization, such as hydroquinone, p-methoxyphenol, dinitrobenzene, p-quinone, methylene blue, beta-naphthol, N-nitrosamines such as N-nitrosodiphenylamine, phenothiazine, phosphorous esters such as triphenyl phosphite or the salts and more particularly the alkali metal and aluminum salts of N-nitrosocyclohexylhydroxylamine. The inhibitors can be used in amounts of 0.001% to 3% and preferably 0.01% to 1% by weight, based on the compound of formula I.

In a further embodiment, the acrylate end groups in the compounds of formula I which are to be used according to the present invention can be replaced in an amount from 0.1 to 99 mol %, more particularly 20 to 50 mol %, by radicals of

a) maleic acid or maleic acid derivatives (particularly esters)
b) fumaric acid and esters
c) hydroxyalkyl acrylates
d) vinyl ethers
e) glycidyl (meth)acrylate
f) allyl glycidyl ethers
g) hydroxybutyl vinyl ethers

Preparing the compounds of formula I

In a preferred embodiment, the inventive compounds of formula I

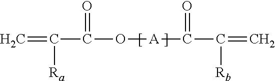

are prepared by reacting a compound of the general formula

HO-AOH

where A is as defined above, with a compound of the formula

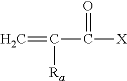

and optionally

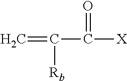

where
Rₐ and R_{b} are each as defined above, and
X is hydroxyl, halogen, preferably chlorine, an acid group, an alkyl group or an alkoxy group of 1 to 100 carbon atoms, in a molar ratio of at least 1:1 to 1:4 and more particularly 1:2.

The reaction is preferably performed in a solvent, such as tertiary monools, preferably tert-butanol, tert-amyl alcohol, pyridine, poly-C1-C4-alkylene glycol di-C1-C4-alkyl ethers, preferably polyethylene glycol di-C1-C4-alkyl ethers, e.g., 1,2-dimethoxyethane, diethylene glycol dimethyl ether, polyethylene glycol dimethyl ether 500, methyl tert-butyl ether, ethyl tert-butyl ether, C1-C4-alkylene carbonates, more particularly propylene carbonate, C3-C6-alkyl acetates, more particularly tert-butyl acetate, tetrahydrofuran, toluene, 1,3-dioxolane, acetone, isobutyl methyl ketone, ethyl methyl ketone, 1,4-dioxane, tert-butyl methyl ether, cyclohexane, methylcyclohexane, toluene, hexane, dimethoxymethane, 1,1-dimethoxyethane, acetonitrile, and also mono- or multi-phasic mixtures thereof.

It can be advantageous to remove liberated water but more particularly to perform the reaction without solvent, i.e., in the acrylic acid derivatives themselves, particularly at a temperature of 20 to 200° C. in the presence of suitable chemical catalysts or biological enzymes, preferably at a pH of 2 to 11.

The compounds of the formula

HO-AOH

which are to be used according to the present invention and are for producing the polymers are preferably block copolymers based on recurring units EO and PO, particularly of the following structure:

-EO-PO-EO-

A block copolymer of the structure -EO-PO-EO- preferably has an EO weight fraction in the range from 5% to 85% by weight and a number average molar mass (Mn) in the range from 200 to 50 000 g/mol.

### Preparing the LCSTs

Preferred LCST polymers are obtainable by
1. direct reaction of preformed alkylene oxide block copolymers with (meth)acrylic acid or acrylic acid derivatives
2. by transesterification of acrylic esters and methacrylic esters under
   a) chemical
   b) enzymatic catalysis.

Useful acrylic or methacrylic esters for transesterification include for example: alkyl (meth)acrylates of straight-chain, branched or cycloaliphatic alcohols having 1 to 40 carbon atoms, for example methyl (meth)acrylate, ethyl (meth)acrylate, n-butyl (meth)acrylate, i-butyl (meth)acrylate, t-butyl (meth)acrylate, pentyl (meth)acrylate, 2-ethylhexyl (meth)acrylate, stearyl (meth)acrylate, lauryl (meth)acrylate, cyclohexyl (meth)acrylate, isobornyl (meth)acrylate; aryl (meth)acrylates such as, for example, benzyl (meth)acrylate or phenyl (meth)acrylate, which may each be unsubstituted aryl radicals or aryl radicals substituted 1-4 times; other aromatically substituted methacrylates such as, for example, naphthyl (meth)acrylate; mono(meth)acrylates of ethers, polyethylene glycols, polypropylene glycols or mixtures thereof with 5-80 carbon atoms, for example tetrahydrofurfuryl methacrylate, methoxy(m)ethoxyethyl methacrylate, 1-butoxypropyl methacrylate, cyclohexyloxymethyl methacrylate, benzyloxymethyl methacrylate, furfuryl methacrylate, 2-butoxyethyl methacrylate, 2-ethoxyethyl methacrylate, allyloxymethyl methacrylate, 1-ethoxybutyl methacrylate, 1-ethoxyethyl methacrylate, ethoxymethyl methacrylate, poly(ethylene glycol) methyl ether (meth)acrylate and poly(propylene glycol) methyl ether (meth)acrylate.

Preferred parameters for a direct synthesis are:
temperature: 80-160° C., preferably 90-130° C.
alcohol/(meth)acrylic acid: 1:0.7-1.2 (molar)
catalyst: sulfuric acid or sulfonic acids
catalyst quantity: 0.1-10% by weight (preferably 0.5-5% by weight) based on starting materials
reaction time: 1-10 h, preferably 1-6 h

Optionally, an entraining agent (e.g., cyclohexane or toluene) is used to remove the water of esterification. The esterification can be performed under atmospheric pressure, under superatmospheric pressure or under reduced pressure not only continuously but also batchwise.

Preferred parameters and starting materials for a transesterification are:
temperature: 30-180° C., preferably 50-130° C.
catalyst quantity: 0.01 to 10% by weight of catalyst preferably from 0.1% to 5% by weight, more preferably from 0.2% to 2% by weight of catalyst based on the entire reaction mixture
catalysts: organometal oxides, organometal halides such as diorganotin oxides, diorganotin halides, alkali metal salts of inorganic acid especially of phosphoric acid, transition metal alkoxides such as titanium alkoxides, alkali amides such as lithium amide, alkali metal and alkaline earth metal alkoxides such as potassium tert-butoxide, acids such as sulfuric acid, alkyl- or arylsulfonic acids e.g., p-toluenesulfonic acid, inorganic acid or basic (mixed) oxides such as zeolites, aluminum-silicon mixed oxide, titanium-silicon mixed oxide or magnesium oxide, or magnesium silicates
   with and without solvent in excesses of (meth)acrylic esters of 1:50 to 1:500 mol/mol, more preferably 1:100 to 1:400 based on the substrate.

A chemical transesterification can be carried out under atmospheric pressure, under superatmospheric pressure or under reduced pressure not only continuously but also batchwise.

An enzymatically catalyzed transesterification is preferably carried out under the following conditions:
temperature: 10-80° C., more preferably at 20-40° C.
pH: 5-8
catalyst: transferase
   with and without solvent in excesses of (meth)acrylic esters of 1:50 to 1:500 mol/mol, more preferably 1:100 to 1:400 based on the substrate.

An enzymatic transesterification can be carried out under atmospheric pressure, under superatmospheric pressure or under reduced pressure not only continuously but also batchwise.

Preferred devices V are for example
a) the devices known in connection with melt spinning of fibers.
   They include, for the process of the invention, depending on the embodiment, either a spraying device immediately following the emergence of fiber at the die, or a bath which preferably comprises an aqueous solution of the LCST polymer. This bath may further comprise a polymerization initiator to conduct the polymerization. However, it is also possible to apply the polymerization initiator to the fiber in an additional further bath. This is more particularly advantageous to avoid any premature polymerization of the polymer in the coagulation bath.
b) the conventional film production rigs, for example based on an extruder which conveys the melt of the substrate and/or melts the substrate, and extrudes it through a die, more particularly a wide slot die, to form a film.

In a further preferred embodiment, effect agents are deposited on the formed body together with the polymerizable LCST polymers. Effect agents are more particularly compounds to improve the properties of the formed body, more particularly of the films and fibers, for example UV stabilizers, pigments, nanoparticles, IR-absorbing compounds, etc. For this, the effect agents can preferably be comprised in bath B together with the polymers.

The formed articles of the present invention, i.e., films and fibers, can be drawn in a conventional manner, including more particularly after application and polymerization of the polymerizable polymer.

### EXAMPLES

### Example 1.1

### Synthesis of Polypropylene Glycol (PPG)

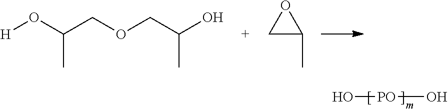

A cleaned 2.5 l steel reactor was initially charged with dipropylene glycol (134.2 g, 1.0 mol) and potassium t-butoxide (4.9 g, 0.4% by weight based on final quantity). The system was three times inertized with nitrogen and heated to 130° C. at which point propylene oxide was added by mass-controlled metering (1102.0 g/l). The system was then allowed to react at 130° C. for 10 hours and cooled down to 50° C.

Yield: 1246.3 g (theory 1236.2 g)

### Example 1.2

### Synthesis of Polyethylene Glycol-Polypropylene Glycol Copolymers

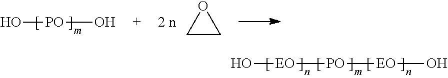

A cleaned 2.5 l steel reactor was initially charged with polypropylene glycol from example 1.1 (309.1 g, 0.25 mol) and potassium t-butoxide (2.11 g, 0.3% by weight based on final quantity). The system was three times inertized with nitrogen and heated to 120° C. at which point ethylene oxide was added by mass-controlled metering (704 g). The system was then allowed to react at 120° C. for 10 hours and cooled down to 80° C. The crude product was admixed with magnesium silicate (5% by weight) and, after 1 h of stirring on a rotary evaporator, pressure filtered through a 900 Seitz filter medium.

The product was characterized by determining its cloud point using method E of EN 1890: 5 g of sample were dissolved in 25 g of aqueous butyldiglycol solution (c=250 g/l) and heated.

### Example 1.3

### Synthesis of (Polyethylene Glycol-Polypropylene Glycol) Diacrylate

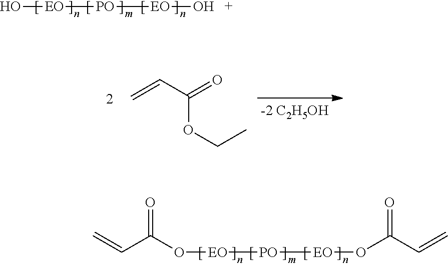

The following were combined in a 6 l four-neck flask: PEG-PPG-PEG (481.50 g, 0.0601875 mol) from example 1.2, ethyl acrylate (1928.3 g, 19.260 mol), molecular sieve 5 Å powder (Fluka) 55.5 g (10 times the amount based on theoretical amount of alcohol formed). The following were added as stabilizers: 4-methoxyphenol (MeHQ): 197.2 mg; (Aldrich) (99% [GC]) (400 ppm based on theoretic amount of product); phenothiazine (PTZ): 5.0 mg (Fluka) (purum; ≧98.0% [GC]) (10 ppm based on theoretical amount of product).

Novozym 435 (33.71 g) (7.0% by weight based on starting material) was added at about 30° C. during the heating phase. The batch was stirred for 23 h at 40° C. and 150 rpm using a glass PTFE intensive stirrer with air introduction.

The batch was then filtered off with suction through a 4 l glass filter nutsche G 2 filled with silica gel 60 (0.040-0.064 mm) at about 500-600 mbar, washed with 4 l of acetone and dried in a rotary evaporator with air introduction to remove ethyl acrylate residues.

Yield: 495 g of clear oil, solidifies at room temperature.

The cloud point was characterized using method E of EN 1890: 5 g of sample were dissolved in 25 g of aqueous butyldiglycol solution (c=250 g/l) and heated.

Further compounds (examples 2.3 and 3.3) were synthesized and characterized similarly to example 1.3. The table which follows shows properties of the synthesized (polyethylene glycol-polypropylene glycol) diacrylates in an overview:

| Product | Example 1.3 | Example 2.3 | Example 3.3 |
|---|---|---|---|
| Pluronic CP [° C.] | ~100 | 78 | >95 |
| n (EO) | 32 | 10 | 35 |
| m (PO) | 21 | 15 | 30 |
| diacrylate CP [° C.] (to E) | 65 | 48 | 75 |
| MW theory [kDa] | 4 | 1.9 | 8 |
| GPC obs.: [kDa] | 4 | 2 | 8 |
| OH number obs.: | 0 | 0.1 | 0.1 |

### Example 2

### Synthesis of (Polyethylene Glycol-Polypropylene Glycol) Dimethacrylate

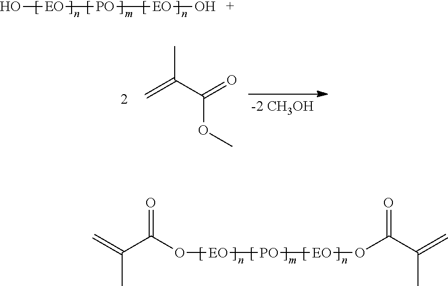

A 750 ml Miniplant reactor equipped with Oldershaw column, liquid distributor, anchor stirrer and vacuum pump (VARIO PC 3001) was initially charged with methyl methacrylate (MMA; 400 g, 4 mol) and the polyetherol of example 1.2 (384 g, 0.08 mol). The stabilizer 4-methoxyphenol (MEHQ) (89 mg, 120 ppm) and the catalyst tripotassium phosphate (2.04 g, 12 mol %) were added. The reaction mixture was heated to 110° C. and methanol was distilled off continuously during 3.5 h. The total amount of distillate amounted to 242 g. The amount of transesterification product obtained was 373 g. The purity of the transesterification product by 1H NMR was: 9% of residual polyetherol, 91% of diester.

### Example 3

### Fiber Coating

Fiber coating was tested using a melt-spinning process for textile grade polyethylene glycol terephthalate (type: RT20, I.V.=0.63 dl/g) as an example. An aqueous solution was provided for this purpose consisting of (% by weight):

10% of LCST polymer as per example 1.3
0.5% of ethylenediaminetetraacetic acid sodium salt
0.1% of adhesion promoter
0.5% of 2,2′-azobis[2-(2-imidazolin-2-yl)propane] dihydrochloride free-radical initiator

A two-stage extrusion spinning rig (POY, FDY) was used to obtain microfibers (120 dtexf32) from a melt at a die temperature of 295° C. In the course of the cooling profile, the fiber was contacted with the LCST polymer solution at a temperature of 80-100° C. (about 100 cm after emergence of the fiber material from the spinneret die) by spraying. The microfibers were wound up at a speed of 3200 m/min and had a filament diameter of 17 micrometers. The mass increase of the fiber was 1-2%. The microfiber and the corresponding fibrous yarn was subsequently characterized by physical methods in comparison with a reference without spraying with the LCST polymer solution:

| | Reference | Example 3 |
|---|---|---|
| Fibrous yam | | |
| elongation [%] (1.2 m) | 114 | 116 |
| tenacity [cN/tex] (1.2 m) | 25.7 | 25.7 |
| modulus [cN/tex] (1.2 m) | 260 | 260 |
| coefficient of fiber/fiber friction f_{f/f} | 0.130 | 0.150 |
| coefficient of fiber/ceramic friction f_{f/c} | 0.06 | 0.25 |
| surface resistance [Ω] | 10¹⁷ | 10¹⁴ |
| Microfiber | | |
| elongation [%] (1.2 m) | 26 | 24 |
| tenacity [cN/tex] (1.2 m) | 39 | 39 |
| modulus [cN/tex] (1.2 m) | 800 | 900 |
| coefficient of fiber/fiber friction f_{f/f} | 0.025 | 0.075 |
| coefficient of fiber/ceramic friction f_{f/c} | 0.4 | 0.9 |
| surface resistance [Ω] | 10¹⁷ | 10¹³ |

The advantageous properties of the sample which is in accordance with the present invention (example 3) manifest in the following values in particular: comparable mechanical properties (elongation, tenacity, tensile modulus) of fibers coupled with reduced electrical resistance. The reduced electrical fiber resistance can reduce the electrostatic charge buildup of textiles.

We claim:

1. A process for producing coatings based on an lost polymer P on the surface of a formed article from a meltable substrate S, more particularly on fibers in a melt-spinning process or self-supporting films after extrusion, which process comprises
a) providing the substrate in molten form,
b) forming the molten substrate via a suitable device v, preferably a die or slot, into a formed article, more particularly into a fiber or a self-supporting film, wherein
c) the formed article has a temperature above the cloud point of said polymer p on exit from said device v, and
d) contacting the surface of the formed article with said polymer p above said cloud point to deposit the polymer,
wherein said polymer p comprises polymerizable double bonds and the polymerization of the double bonds is initiated after deposition of the polymer on the surface to form a preferably crosslinked coating on the surface.

2. The process according to claim 1 wherein the formed article after emergence from said device V is led into a preferably aqueous bath B comprising said polymer P and optionally a polymerization initiator, wherein the temperature is chosen such that as it enters the bath the formed article has a temperature above the cloud point, said polymer P deposits and the bath has a temperature below the cloud point and the polymerization is performed at a temperature below the LOST.

3. The process according to claim 1 wherein the formed article emerging from said device V is immediately thereafter led at a temperature above the cloud point into a spraying device and is sprayed therein with said polymer P, preferably in the form of an aqueous solution, wherein the temperature of the spray-dispensed polymer P is below the cloud point, to deposit the polymer on the surface of the substrate.

4. The process according to claim 1, wherein
the formed article after emergence from said device V is led into a preferably aqueous bath B comprising said polymer P and optionally a polymerization initiator, wherein the temperature is chosen such that as it enters the bath the formed article has a temperature above the cloud point,
said polymer P deposits on the formed article, and
the bath has a temperature below the cloud point and the polymerization is performed at a temperature below the cloud point.

5. The process according to claim 1, wherein said polymer P is a polyalkylene oxide having at least two terminal optionally substituted acrylic acid radicals.

6. The process according to claim 5 wherein the optionally substituted acrylic acid radical is an acrylic or methacrylic acid radical.

7. The process according to claim 1, wherein the LCST of said polymer P is between 40-80° C.

8. The process according to claim 1, wherein said polymer P is a polyalkylene oxide of the following general formula: 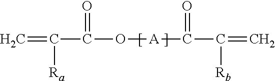
where Rₐ and R_{b} are each independently hydrogen or an alkyl radical, more particularly of 1-4 carbon atoms, more particularly methyl,
A is at least one radical of the formula 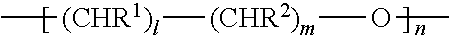
where two or more radicals A may be the same or different and where
R¹ to R² are the same or different and are each H, C1- to C5-alkyl, more particularly methyl, ethyl, propyl or aryl, more particularly phenyl,
l is 1 or 0
m is 1 or 0 provided l+m is at least 1,
n is from 1 to 100.

9. The process according to claim 8 wherein A is at least one of the following radicals: 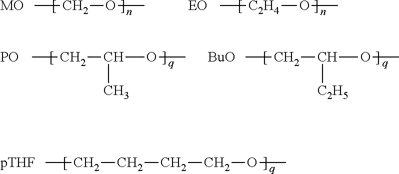
where n and q are the same or different and are each from 1 to 100.

10. The process according to claim 9 wherein A is a block copolymer comprising the structure
-(EO)-(PO)-(EO)-
where EO and PO are each as defined in claim 9.

11. The process according to claim 1, wherein said polymer P conforms to the following formula: 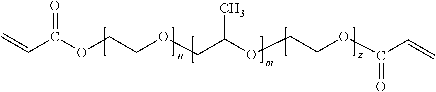
where
n and z are the same or different and are each an integer from 5 to 100 and more particularly from 20 to 40,
m is an integer from 5 to 100 and more particularly from 15 to 30.

12. The process according to claim 1, wherein the substrate is a polyamide, polyester, polypropylene or polyurethane.

13. The process according to claim 1, wherein the substrate is a glass.

14. The process according to claim 2 wherein the polymerization of the double bonds is performed subsequently to the treatment in bath B.

15. A formed article obtainable according to claim 1.
